(19) United States
(12) Patent Application Publication
(10) Pub. No.: US 2013/0094187 A1
(43) Pub. Date: Apr. 18, 2013

(54) LED BACKLIGHT DEVICE AND LIQUID CRYSTAL DISPLAY DEVICE

(71) Applicant: Kentaro Kamada, Osaka-shi (JP)

(72) Inventor: Kentaro Kamada, Osaka-shi (JP)

(73) Assignee: SHARP KABUSHIKI KAISHA, Osaka-shi, Osaka (JP)

(21) Appl. No.: 13/806,161

(22) PCT Filed: Apr. 19, 2011
(86) PCT No.: PCT/JP2011/059577

§ 371 Date: Dec. 21, 2012

(30) Foreign Application Priority Data
Jun. 25, 2010 (JP) 2010-144583

(51) Int. Cl. G02F 1/1335

(52) U.S. Cl. CPC G02F 1/133603
USPC 362/97.3

(57) ABSTRACT

Disclosed are a direct LED backlight device and a liquid crystal display device, which is provided with the backlight device. In the LED backlight device (BL1), cost is reduced by simplifying an assembly step with the reduced number of components that constitute the backlight device, and even with the reduced number of components, the service life of an LED package can be stabilized by dissipating heat. A wiring pattern (2) for driving an LED chip is provided on a heat dissipating board (4), and an LED package (1) is directly mounted on the heat dissipating board (4) by mounting, on the wiring pattern (2), each sub-mounting board having the LED chip mounted thereon.

### TECHNICAL FIELD

The present invention relates to a backlight device that irradiates a liquid crystal panel with light from behind and a liquid crystal display device incorporating the backlight device, and the present invention specifically relates to an LED backlight device and a liquid crystal display device that use an LED as a light source.

### BACKGROUND ART

Along with the improvement in light emitting efficiency and light emission intensity of LEDs, illumination devices using an LED (Light Emitting Diode) have recently been well on their way to practical use; the LED is regarded as environment-friendly for its long life and small power consumption. Ever since a blue LED chip was developed, there have been developed white LED light sources that emit white light by combining a blue LED chip and a fluorescent material which emits excitation light of a predetermined wavelength by being excited with light emitted from the blue LED chip, and white LED light sources that generate white light by using LED chips of the three primary colors, namely, blue, green, and red.

Thus, as backlights for use in liquid crystal display devices and the like, LED backlight devices provided with such white LED light sources are used. As backlights for use in liquid crystal display devices, there have been known a direct type backlight device where a light source is disposed facing the rear surface of a display screen, and an edge-light type backlight device where a light source is disposed at a side of a display screen, and a light guide plate is disposed facing the rear surface of the display screen such that light from the light source enters the light guide plate through a side surface of the light guide plate to be reflected inside the light guide plate to be outputted as planar light through a light emission surface of the light guide plate.

The edge-light type backlight device can be formed thin easily, since a light source portion is disposed at a side of a display screen and a plate-shaped light guide plate is disposed behind the display screen, and thus the edge-light type backlight device is preferable in achieving a thin liquid crystal display device and the like. On the other hand, since the direct type backlight device irradiates a display screen with light coming directly from a light source which is disposed behind the display screen, it is easy to achieve high-brightness illumination and area-by-area control of the brightness of light emission with the direct type backlight device, and this makes the direct type backlight device preferable.

In both of the two types of backlight devices, an LED light source is an LED package formed by packaging and sealing an LED chip mounted on a submount substrate with a transparent resin or a transparent resin containing a predetermined fluorescent material. A plurality of LED packages are integrally fitted to an LED mounting substrate to form a module, and thereby a light emitting member (an LED module) of a predetermined shape is formed.

A large number of LED mounting substrates (LED modules) on each of which a plurality of LED packages are mounted are laid out on a backlight chassis to form an illumination device such as a direct type backlight having a large light emission area. Thus, conventional LED backlight devices are configured such that LED mounting substrates are attached to a backlight chassis and LED packages are mounted on the LED mounting substrates.

An example of the configuration of such a backlight device and a liquid crystal display device incorporating the backlight device is shown in FIG. 4. As shown in the figure, a liquid crystal display device 69 includes a liquid crystal panel 59, an LED backlight device 49 supplying light to the liquid crystal panel 59, and housings HG (a front housing HG1, a rear housing HG2) holding these members therebetween.

The liquid crystal panel 59 is formed by bonding an active matrix substrate 51 including switching elements such as a TFT (Thin Film Transistor) and a counter substrate 52 disposed to face the active matrix substrate 51 to each other with a seal member (not shown). Then liquid crystal (not shown) is charged in a gap between the two substrates 51, 52.

Polarization films 53 are provided on a light receiving side of the active matrix substrate 51 and on a light output side of the counter substrate 52. The thus configured liquid crystal display panel 59 displays images by exploiting the variation of transmittance attributable to tilt of liquid crystal molecules.

An LED backlight device 49 located right under the liquid crystal display panel 59 includes LED modules MJ, a backlight chassis 41, a reflection sheet 42, a diffusion plate 43, a prism sheet 44, and a lens sheet 45. The LED modules MJ are each composed of an LED mounting substrate 21 and a plurality of LED packages 1 mounted on a mounting surface 21U of the LED mounting substrate 21.

The LED mounting substrate 21 has a plate-like and rectangular shape, and a plurality of electrodes (not shown) are arranged on a mounting surface 21U of the LED mounting substrate 21. On these electrodes, LED chips are attached via a submount substrate. The electrodes and the LED chips are electrically connected to each other by, for example, wire bonding.

On the mounting surface 21U of the LED mounting substrate 21, there is formed a resist film (not shown) to serve as a protection film. The color of this resist film is, for example, white, which has reflectivity. With a white resist film, incident light on the white resist film is reflected thereby to travel outward, and this helps prevent light absorption by the LED mounting substrate 21, which is a cause of uneven light intensity.

The LED backlight device 49 shown in the figure is equipped with, for example, comparatively short mounting substrates 21 on each of which five LED packages 1 are arranged in a row, and comparatively long mounting substrates 21 on each of which eight LED packages 1 are arranged in a row.

Thus, a row of the five LED packages 1 and a row of the eight LED packages 1 are aligned to form a row of thirteen LED packages 1, and further, the two kinds of mounting substrates 21 are arranged in a direction crossing (for example, perpendicular) to the direction in which the thirteen LED packages 1 are aligned (here, the LED packages 1 are equally spaced from each other). Furthermore, the arrangement pattern and the number of the LED packages are determined appropriately according to the screen size and the required brightness.

As a result, the LED packages 1 are arranged in a matrix pattern (to put it another way, the LED modules MJ are arranged in a plane), and light from these LED packages 1 are mixed into planar light (here, for the sake of convenience, a direction in which the two different kinds of mounting substrates 21 are arranged in a row will be referred to as direction X, a direction in which the LED mounting substrates 21 of the same kind are arranged side by side will be referred to as direction Y, and a direction that crosses both direction X and direction Y will be referred to as direction Z).

The backlight chassis 41 is a box-like member, for example, and a plurality of LED modules MJ are accommodated in the backlight chassis 41 by being laid out on a bottom surface 41B of the backlight chassis 41. The LED mounting substrates 21 of the LED modules MJ are fastened to the bottom surface 41B of the backlight chassis 41 with unillustrated rivets. Furthermore, on the backlight chassis 41, the reflection sheet 42, the diffused plate 43, the prism sheet 44, and the lens sheet 45 are stacked in this order.

The reflection sheet 42 is an optical sheet having a reflection surface 42U, and covers the plurality of LED modules MJ with a surface thereof that is opposite from the reflection surface 42U facing the plurality of LED modules MJ. However, the reflection sheet 42 includes apertures 42H aligned to the positions of the LED packages 1, such that light emitting surfaces of the LED packages 1 are exposed through the reflection sheet 42U.

With this configuration, even if part of light outputted from the LED packages 1 travels toward the bottom surface 41B of the backlight chassis 41, the part of light is reflected by the reflection surface 42U of the reflection sheet 42 to travel away from the bottom surface 41B. Thus, the existence of the reflection sheet 42 enables the light from the LED packages 1 to travel toward the diffusion plate 43, which faces the reflection surface 42U, without loss.

The diffusion plate 43 is an optical sheet superposed on the reflection sheet 42, and diffuses light emitted from the LED modules MJ and light reflected from the reflection sheet 42U. That is, the diffusion plate 43 diffuses planar light formed by the plurality of LED modules MJ (to put it in another way, the plurality of LED packages 1 which are arranged in a matrix pattern), to thereby deliver the light all over the liquid crystal display panel 59.

The prism sheet 44 is an optical sheet that is superposed on the diffusion plate 43. In the prism sheet 44, for example, triangular prisms extending (linearly) in one direction are aligned in the sheet surface in a direction that crosses the one direction. With this configuration, the prism sheet 44 deflects a radiation characteristic of light coming from the diffusion plate 43. Preferably, the prisms each extend along direction Y along which a smaller number of LED packages 1 are aligned, and the prisms are arranged side by side along direction X along which a larger number of LED packages 1 are aligned.

The lens sheet 45 is an optical sheet that is superposed on the prism sheet 44. The lens sheet 45 contains fine particles dispersed therein to refract and scatter light. This enables the lens sheet 45 to prevent local concentration of light that comes from the prism sheet 44 to thereby reduce light and shade variation (light intensity variation).

And, the LED backlight device 49 configured as described hereinabove makes planar light formed by the plurality of LED modules MJ pass through the plurality of optical sheets 43 to 45, and supplies the planar light to the liquid crystal panel 59. Thereby, the liquid crystal display panel 59, which does not emit light by itself, receives light (backlight light) from the LED backlight device 49, and thereby improves display function.

As discussed hereinabove, the conventionally-configured LED backlight device is produced through a complex process including a step of producing LED packages each by first mounting an LED chip on a submount substrate, a step of mounting the thus produced LED packages on LED mounting substrates to produce LED modules, and further, a step of fitting the thus produced LED modules to a backlight chassis.

To make the process less complex, it is necessary to simplify the backlight-fitting process described above, and there has already been disclosed a liquid crystal display device, for example, where a backlight assembly process is simplified by using a planar light source where LED chips are mounted in a bear chip state on a base substrate and an optical layer is integrally stacked on the LED chips (see, for example, Patent Literature 1).

### CITATION LIST

### Patent Literature

Patent Literature 1: JP-A-2006-210880

### SUMMARY OF INVENTION

### Technical Problem

The base substrate described in the above-listed Patent Literature 1 is a double-layer substrate provided with a lower, PCB substrate, and an upper, heat dissipating substrate. LED chips are mounted on the heat dissipating substrate via a chip base film formed of an electrically insulating material; conductors are provided on a lower surface of the PCB substrate for driving the LED chips; and plugs are provided penetrating the substrates to electrically connect the conductors and the LED chips. Furthermore, the base substrate is integrally formed with a mold frame and optical sheets as a backlight portion, and firmly fitted to a chassis.

This means that the LED chips are first mounted on the base substrate and then the base substrate is mounted on another substrate, and in this respect, the invention disclosed in Patent Literature 1 is the same as the conventional example, and the backlight assembly process is not simplified sufficiently. Thus, further simplification is required to be achieved by, for example, reducing the number of components.

Besides, electronic components such as LED chips and IC chips mounted on a substrate generate heat in operation, and the heat raises the temperature of the electronic components. Such increase in temperature may cause malfunction and shorten the product life. To prevent such inconvenience, a configuration designed to simplify the assembly process by reducing the number of components needs to have excellent heat dissipating performance as well.

In view of the above problems, an object of the present invention is to provide a direct type LED backlight device and a liquid crystal display device incorporating the backlight device capable of achieving simple assembly process and cost reduction by reducing the number of components, and simultaneously capable of ensuring sufficient heat dissipation performance to thereby stabilize the life of an LED package in spite of the reduction of the number of components.

### Solution to Problem

To achieve the above object, according to one aspect of the present invention, an LED backlight device includes an LED package provided with an LED chip as a light source, a submount substrate on which the LED chip is mounted, and a sealing resin which seals the LED chip; an LED mounting member where a wiring pattern for driving the LED chip is formed and a predetermined number of LED packages are mounted as the LED package; and a heat dissipating member having a plurality of LED mounting members mounted thereon as the LED mounting member, and dissipating heat generated by the LED chip when driven, the LED backlight device irradiating a liquid crystal panel with light emitted by a plurality of LED packages disposed behind the liquid crystal panel as the LED package. Here, a heat dissipating substrate is provided on which the plurality of LED packages are integrally mounted at a predetermined pitch, the heat dissipating substrate has a wiring pattern formed thereon for driving the LED chip, the submount substrate of each of the LED packages is mounted on the wiring pattern such that the LED packages are mounted directly on the heat dissipating substrate, and the heat dissipating substrate serves both as the LED mounting member and as the heat dissipating member.

With this configuration, where the LED packages are mounted directly on the heat dissipating substrate on which the wiring pattern is formed, it is possible to omit the conventionally-used LED mounting substrates on each of which a predetermined number of LED packages are integrally mounted. This contributes to simplifying the process of manufacturing a backlight device. Furthermore, the direct fitting of the LED packages to the heat dissipating substrate ensures sufficient heat dissipating performance, which contributes to stabilizing the life of the LED package product.

According to an embodiment of the present invention, in the LED backlight device configured as described above, it is preferable that the heat dissipating substrate be a backlight chassis. With this configuration, the backlight chassis, which forms a frame body of the backlight device, is used as an LED package mounting substrate and as the heat dissipating substrate, it is possible to reduce cost for the substrates and improve the heat dissipating performance.

According to an embodiment of the present invention, in the LED backlight device configured as described above, it is preferable that the backlight chassis be made of a sheet metal, that a resist layer be formed on the backlight chassis made of a sheet metal, and that the wiring pattern be formed on the resist layer. With this configuration, even though the backlight chassis is made of a sheet metal, since the wiring pattern is formed on the resist layer serving as an electrically insulating layer, it is possible to prevent a fault such as a short circuit or a leakage, and thus the light emission of the LED packages can be appropriately controlled.

According to an embodiment of the present invention, in the LED backlight device configured as described above, it is preferable that the backlight chassis be made of an aluminum sheet. With this configuration, thanks to the high thermal conductivity of the aluminum sheet, it is possible to further improve the heat dissipating performance.

According to another aspect of the present invention, a liquid crystal display device includes a liquid crystal panel and the LED backlight configured as described in any one of claims 1 to 4. With this configuration, by providing a liquid crystal display device with a backlight device which has a smaller number of components and thus is assembled through a simpler process and which is excellent in heat dissipating performance, it is possible to obtain a liquid crystal display device capable of reducing the production cost and improving the reliability.

### Advantageous Effects of Invention

According to the present invention, in a direct type LED backlight device and a liquid crystal display device incorporating the backlight device, a wiring pattern for driving LED chips is formed on a heat dissipating substrate, submount substrates each having an LED chip mounted thereon are individually mounted on the wiring pattern, to thereby mount LED packages directly on the heat dissipating substrate. As a result, it is possible to obtain an LED backlight device capable of achieving cost reduction by reducing the number of components and thereby simplifying the assembly process, and simultaneously capable of ensuring sufficient heat dissipation to thereby stabilize the life of LED packages in spite of the reduction of the number of components.

### BRIEF DESCRIPTION OF DRAWINGS

FIG. 1 is a diagram schematically illustrating an LED backlight device according to the present invention;

FIG. 2 is a diagram schematically illustrating a conventional LED backlight device;

FIG. 3A is a schematic plan view of an LED backlight device according to the present invention;

FIG. 3B is a schematic plan view of a conventional LED backlight device;

FIG. 4 is an exploded perspective view of a liquid crystal display device; and

FIG. 5 is an exploded perspective view of a television receiver incorporating a liquid crystal display device.

### DESCRIPTION OF EMBODIMENTS

Hereinafter, embodiments of the present invention will be described with reference to the accompanying drawings. The same components will be identified by common reference symbols, and detailed description of them will be omitted if possible.

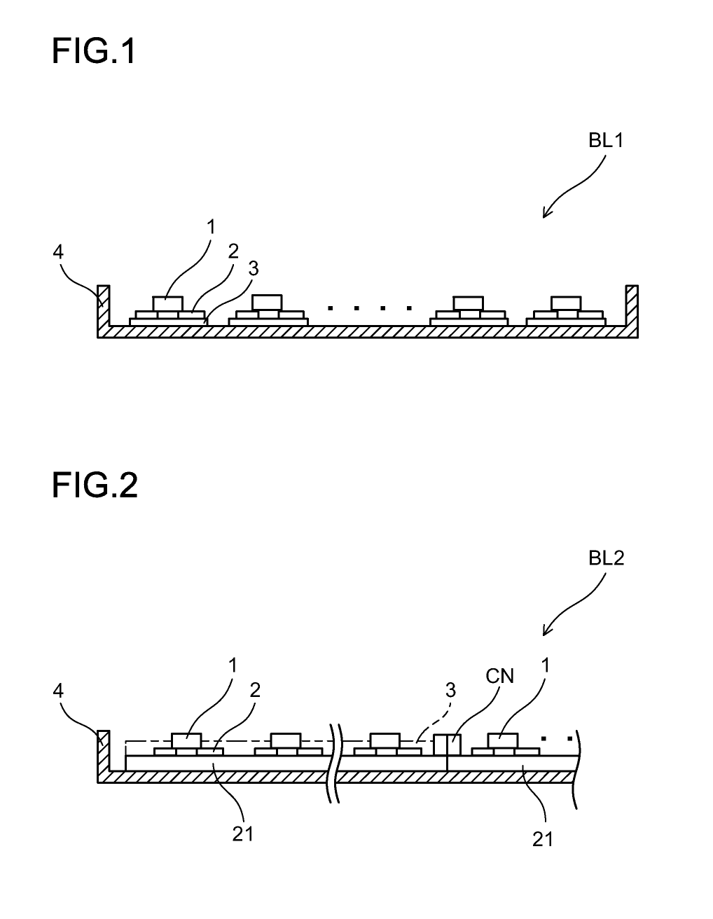

First, with reference to FIG. 1, a description will be given of an example of an LED backlight device according to the present invention.

As shown in FIG. 1, an LED backlight device BL1 according to the present embodiment is configured such that a plurality of LED packages 1 are directly mounted on a heat dissipating substrate 4, and, for example, a resist layer 3 is formed as an electrically insulating layer on the heat dissipating substrate, a wiring pattern 2 is formed on the resist layer 3, and the LED packages 1 are mounted on the wiring pattern 2.

The LED packages 1 are conventionally known ones, each including an LED chip as a light source, a submount substrate on which the LED chip is mounted, and a sealing resin which seals the LED chip, and thus a detailed description thereof will not be given here.

The wiring pattern 2 provided on the heat dissipating substrate 4 is, for example, a copper wiring pattern formed on the resist layer 3, and the wiring pattern 2 is provided for driving the LED packages 1. The submount substrates of the LED packages 1 are each mounted at a predetermined position on the wiring pattern 2 to achieve electric connection, to enable the mounted LED chips to emit light.

The resist layer 3, which is an electrically insulating layer, is made of an electrically insulating material whose main component is an epoxy resin, and can be formed by screen printing at a predetermined portion where the wiring pattern 2 is to be formed.

Since the wiring pattern 2 is formed on the resist layer 3 which is an electrically insulating layer, the heat dissipating substrate 4 may be either electrically insulating or electrically conductive, and, for example, a rigid resin having a heat dissipating characteristic or a sheet metal having high heat conductivity may be used as the heat dissipating substrate 4. It is particularly preferable to use a sheet metal that is excellent both in strength and in heat conductivity as the heat dissipating substrate 4. Thus, a backlight chassis can be used as the heat dissipating substrate 4, and the LED packages 1 can be mounted directly on the backlight chassis which forms a frame body of the backlight device BL1.

With this configuration, it is possible to omit conventionally used LED mounting substrates on each of which a predetermined number of LED packages 1 are integrally mounted to form a module. By thus omitting the LED mounting substrates, it is possible to omit the steps of producing LED modules each having a predetermined number of LED packages 1 mounted thereon, and this makes it possible to simplify the process of manufacturing the LED backlight device BL1. Furthermore, the direct fitting of the LED packages 1 to the heat dissipating substrate 4 ensures sufficient heat dissipating performance, to stabilize the life of the LED package product.

Furthermore, the backlight chassis, which forms the frame body of the backlight device BL1, is used as the LED package mounting substrate and the heat dissipating substrate, and with this configuration where the heat dissipating substrate functions both as an LED mounting member and as a heat dissipating member, it is possible to achieve both cost reduction and improved heat dissipation.

As shown in FIG. 2, a conventional LED backlight device BL2 is configured such that a predetermined number of LED packages 1 are mounted on a wiring pattern 2 formed on an LED mounting substrate 21 which is a mounting member, and a plurality of LED mounting substrates 21 are laid out on a heat dissipating substrate 4 which is a heat dissipating member. A resist layer 3, which is indicated by an imaginary line, is used to electrically insulate and protect a front surface of the LED mounting substrate 21. Besides, the LED mounting substrates 21 are connected with each other by connectors CN, to increase the number of LED packages disposed in each row, and thereby is achieved an LED backlight device suitable for a large display screen.

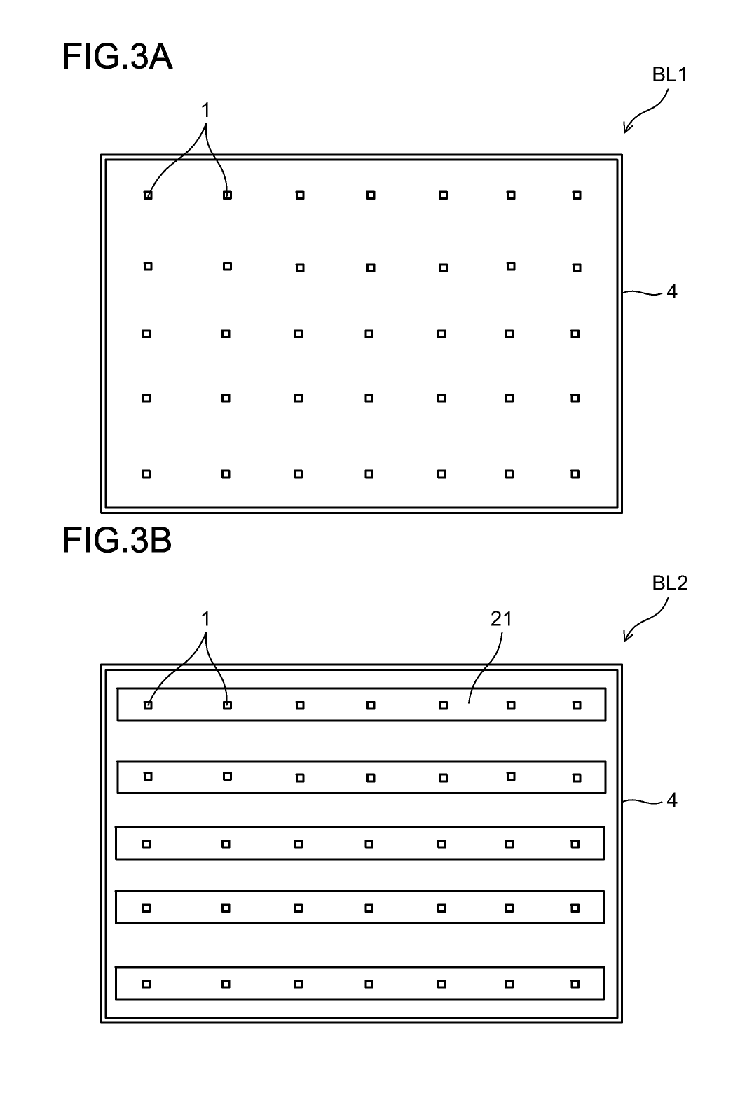

For example, as shown in FIG. 3B, to build the LED backlight device LB2 as a comparatively small one where a total of thirty-five LED packages 1 are arranged such that seven LED packages 1 are arranged in each row and five LED packages 1 are arranged in each column, five LED mounting substrates 21 each having seven LED packages 1 mounted thereon in a row are laid out such that seven columns of five LED packages 1 are formed. That is, seven LED packages 1 are mounted on each of the five LED mounting substrates 21 and the LED mounting substrates 21 having the LED packages 1 mounted thereon are laid out on the heat dissipating substrate 4 side by side to form five columns

To produce the LED backlight device BL1 to be of the same size as the above LED backlight device BL2, as shown in FIG. 3A, a total of thirty-five LED packages 1 are directly disposed on the heat dissipating substrate 4 such that seven LED packages 1 are aligned in each row and five LED packages 1 are aligned in each column. Here, a predetermined wiring pattern is formed on the heat dissipating substrate 4 in advance, and the plurality of LED packages 1 are arranged at a predetermined pitch distance.

To make the LED backlights BL1 and BL2 match a larger display area, a larger number of LED packages 1 are disposed at the predetermined pitch distance in the LED backlight BL1, while LED mounting substrates 21 having a predetermined number of LED packages 1 mounted thereon are connected to each other via, for example, the connectors CN in the LED backlight device BL2.

Thus, the conventional LED backlight device BL2 is configured such that the LED mounting member and the heat dissipating member are provided as separate members, while the LED backlight device BL1 according to the present embodiment is configured such that the heat dissipating substrate 4 functions both as the LED mounting member and as the heat dissipating member. That is, in comparison with the conventional LED backlight device BL2, the LED mounting substrates 21 and the connectors CN are omitted in the LED backlight device BL1.

In addition, the process of assembling the conventional LED backlight device BL2 needs to include a step of mounting the LED packages 1 on the LED mounting substrates 21 and a step of laying out the LED mounting substrates 21, on each of which a predetermined number of LED packages 1 are mounted, on the heat dissipating substrate 4 in a predetermined arrangement, but in contrast, the process of assembling the LED backlight device BL1 according to the present embodiment include only a step of mounting the LED packages 1 directly on the heat dissipating substrate, and this helps simplify the process of manufacturing the LED backlight device. Furthermore, the direct fitting of the LED packages 1 to the heat dissipating substrate 4 ensures sufficient heat dissipating performance, which contributes to stabilizing the life of an LED package product.

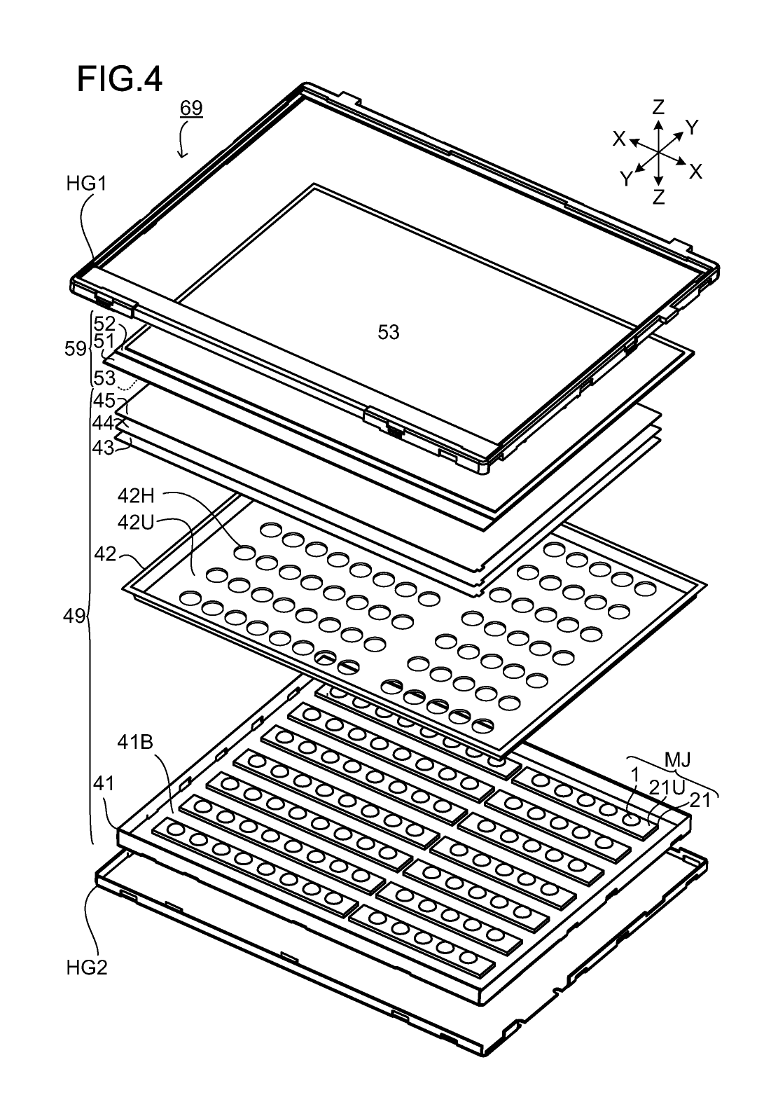

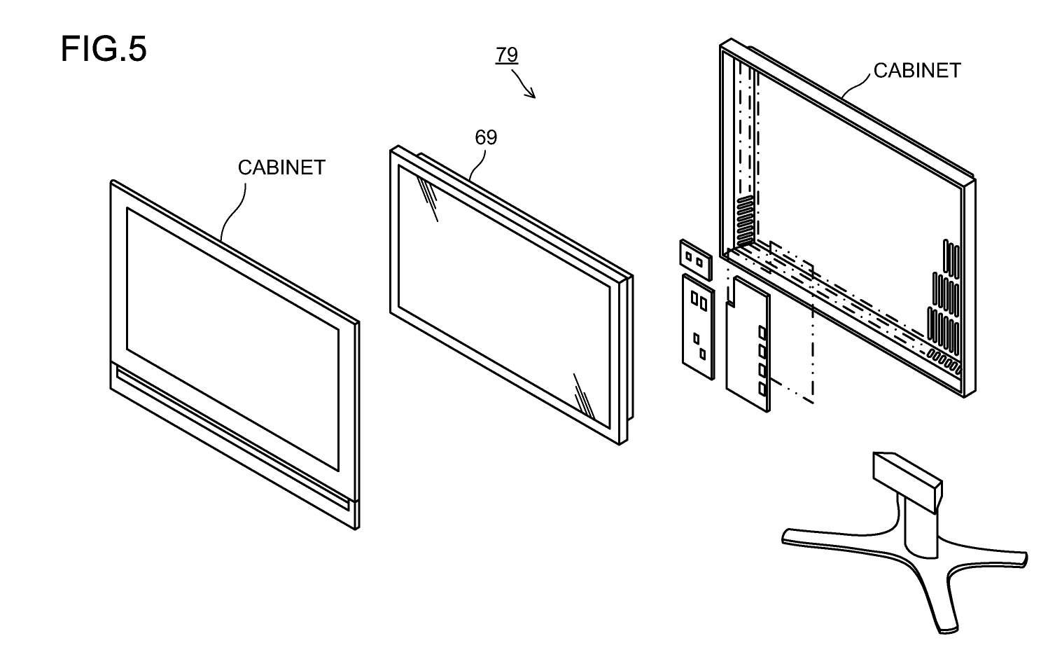

The heat dissipating substrate 4 may be a backlight chassis, and, for example, the LED packages 1 are directly mounted on the backlight chassis 41 used in the conventional LED backlight device 49 shown in FIG. 4. That is, the backlight device BL1 according to the present embodiment is a backlight device 49 configured such that a predetermined wiring pattern is formed on the backlight chassis 41 and the LED packages 1 are directly mounted thereon.

With this configuration, it is possible to quickly dissipate heat via the backlight chassis 41 from the LED packages 1 that generates heat when driven. Preferably, the backlight chassis is made of a material having a heat dissipating characteristic, such as a sheet metal. It is more preferable if the backlight chassis 41 is made of an aluminum sheet which has an excellent heat dissipating characteristic, because then even better heat dissipation can be achieved.

Moreover, it is preferable if the liquid crystal display device 69 shown in FIG. 4 is configured to incorporate the aforementioned LED backlight device BL1, because then it is possible to reduce the number of components of the backlight device to thereby simplify the assembly process, and further, it is possible to obtain a liquid crystal display device provided with a backlight device that has an excellent heat dissipation characteristic, and as a result, the production cost of the liquid crystal display device 69 can be reduced and the reliability of the liquid crystal display device 69 can be improved.

The liquid crystal display device 69 can be used as the display portion of a liquid crystal television set 79, for example, as shown in FIG. 5. The liquid crystal television set 79 receives television broadcast signals and displays images, and thus it can be called a television receiver.

As has been described above, according to the present invention, in a direct type LED backlight device and a liquid crystal display device provided with the backlight device, a wiring pattern for driving LED chips is formed on a heat dissipating substrate, submount substrates each having an LED chip mounted thereon are individually mounted on the wiring pattern, to thereby mount LED packages directly on the heat dissipating substrate. As a result, it is possible to obtain an LED backlight device capable of achieving cost reduction by reducing the number of components and thereby simplifying the assembly process, and simultaneously capable of exhibiting an excellent heat dissipating characteristic to stabilize the life of an LED package even with a smaller number of components.

Furthermore, in the configuration where the backlight chassis is used also as a heat dissipating substrate, the backlight chassis which is the frame body of the backlight device is used as a substrate member serving both as the LED package mounting substrate and as a heat dissipating substrate. With this configuration, it is possible to reduce cost of substrates and improve heat dissipation.

Thus, with the backlight device according to the present invention, it is possible to reduce the production cost, and also, to improve heat dissipation to thereby improve the life and reliability of LED packages.

### INDUSTRIAL APPLICABILITY

The LED backlight device according to the present invention is preferably usable as an LED backlight device of a liquid crystal display device capable of achieving reduced production cost and stabilizing the life of the LED packages to thereby achieve improved reliability.

### LIST OF REFERENCE SYMBOLS

1 LED package

2 wiring pattern

3 resist layer

4 heat dissipating substrate

21 LED mounting substrate

49 LED backlight device

59 liquid crystal panel

69 liquid crystal display device

BL1 LED backlight device (device according to the present invention)

BL2 LED backlight (conventional device)

1. An LED backlight device, comprising:
an LED package provided with an LED chip as a light source, a submount substrate on which the LED chip is mounted, and a sealing resin which seals the LED chip;
an LED mounting member where a wiring pattern for driving the LED chip is formed and a predetermined number of LED packages are mounted as the LED package; and
a heat dissipating member having a plurality of LED mounting members mounted thereon as the LED mounting member, and dissipating heat generated by the LED chip when driven,
the LED backlight device irradiating a liquid crystal panel with light emitted by a plurality of LED packages disposed behind the liquid crystal panel as the LED package,
wherein
a heat dissipating substrate is provided on which the plurality of LED packages are integrally mounted at a predetermined pitch, the heat dissipating substrate has a wiring pattern formed thereon for driving the LED chip, the submount substrate of each of the LED packages is mounted on the wiring pattern such that the LED packages are mounted directly on the heat dissipating substrate, and the heat dissipating substrate serves both as the LED mounting member and as the heat dissipating member.

2. The LED backlight device according to claim 1,
wherein
the heat dissipating substrate is a backlight chassis.

3. The LED backlight device according to claim 2,
wherein
the backlight chassis is made of a sheet metal;
a resist layer is formed on the backlight chassis made of the sheet metal; and
the wiring pattern is formed on the resist layer.

4. The LED backlight device according to claim 3,
wherein
the backlight chassis is made of an aluminum sheet.

5. A liquid crystal display device comprising:
a liquid crystal panel; and
the LED backlight device according to claim 1.

6. A liquid crystal display device comprising:
a liquid crystal panel; and
the LED backlight device according to claim 2.

7. A liquid crystal display device comprising:
a liquid crystal panel; and
the LED backlight device according to claim 3.

8. A liquid crystal display device comprising:
a liquid crystal panel; and
the LED backlight device according to claim 4.
